(19) United States
(12) Patent Application Publication
(10) Pub. No.: US 2004/0153894 A1
(43) Pub. Date: Aug. 5, 2004

(54) Method of measuring the accuracy of a clock signal

(75) Inventor: Robertus Laurentius van der Valk, Dordrecht (NL)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor Inc., Kanata (CA)

(21) Appl. No.: 10/347,726

(22) Filed: Jan. 21, 2003

(51) Int. Cl. G11B 5/00; G06K 5/04; G11B 20/20

(52) U.S. Cl. 714/700

(57) ABSTRACT

A circuit for measuring the accuracy of a clock signal comprising has a first digital phase locked loop receiving an input signal and providing an output signal and a second digital phase locked loop receiving at its input the output signal from the first phase locked loop. One or more measurement terminals are internally connected to one of the phase locked loops to provide a measurement signal.

### BACKGROUND OF THE INVENTION

1. Field of the Invention

This invention relates to the field of digital communications, and in particular to a method of measuring clocking accuracy, for example, in a network.

2. Background of the Invention

With the current evolving technologies in optical and electrical telecommunication domains it is becoming more critical to ensure the clocking accuracy of a network or network services. This is particularly true in the case of Voice Over IP (VoIP), where quality of the voice is related to the delay over the network. It is also true, for instance, in the case of crossconnecting where frameslips may occur.

In a network the clocking is required to meet certain minimum applicable standards. Examples of these standards can be found, for instance in the CCITT, ETSI and Bellcore standards. However, realtime checking of the clocks in the actual network is rarely done because the equipment to do so is very expensive.

FIG. 1 shows a typical circuit for measuring jitter. The incoming signal (coming from some network segment) is first filtered by a phase locked loop (PLL), so that a correct frequency reference without jitter is present. This filtered frequency is phase compared with the unfiltered signal. The phase detector maps the incoming signals into a group of difference and sum frequencies, of which only f1-f2 is the signal of interest. By using a low pass filter (LPF) it is possible to capture that signal and then convert it to a digital signal. The digitized signal can be displayed to provide the jitter measurement.

The maximum accuracy of the measurement method is determined by several factors. The LPF implicitly present in the PLL sets the minimum frequency that can be measured. Below that frequency the PLL leave hardly any signal to track. The accuracy of the Analog-to-digital converter (ADC) is a limitation on the accuracy. Other factors, such as the noise of the phase detector and the noise of the PLL can be significant.

### SUMMARY OF THE INVENTION

The invention provides a system that can accurately measure clocking errors in digital networks.

According to the present invention there is provided a circuit for measuring the accuracy of a clock signal comprising a first digital phase locked loop receiving an input signal and providing an output signal; a second digital phase locked loop receiving at its input said output signal from said first phase locked loop; a measurement terminal for providing a measurement signal; and a multiplexer for selectively connecting said measurement terminal to a signal extraction point in said circuit.

The double PLL has a more predictable behaviour in the presence of a small amount of jitter. The quantization of the acquisition PLL gives rise to nonlinear effects, which manifest themselves as a behaviour that is limited in size but which is otherwise unpredictable (chaotic behaviour). These unpredictable effects can be modeled with a limited variation of the low pass frequency of the acquisition PLL. The double PLL structure typically has the property that the output PLL low pass frequency is low enough to suppress troublesome frequencies.

The output PLL is not hindered by the non-linearities of the acquisition PLL. Since the output PLL does not introduce another level of quantization, the output PLL can behave accurately and predictably.

The multiplexer allows the signals to be selectively extracted from different points in the circuit according to specific requirements.

To use digital PLLs for measurement, the quantitative behaviour of the system must be known. The aspect of interest is noise, namely quantization noise and thermal noise. These together set the limits to the accuracy of measurement, possibly with a dependency on the frequency spectrum of interest.

Some noise sources remain because the PLL employs synchronous detection and thus must hunt for the equilibrium. The PLL never actually reaches equilibrium and will tend to keep on overshooting. This effect is known as the limit cycle because it is oscillatory, but limited in nature. The phase detector on the input introduces its own noise. Although the phase detector can be designed to be fully symmetrical, it is not possible to eliminate noise entirely because part of the noise in the phase detector will be differential. Such noise, however, is very limited. Other noise in the input PLL loop will be fed back. When feedback occurs, the noise will be attenuated, so that the noise no longer plays any significant role.

The double phase-locked loop will typically be driven by a crystal. This crystal will introduce its own source of noise. As the crystal itself is not part of the PLL loop, its noise will not be compensated.

The novel circuit enables the measurement of clocking accuracy in order to provide a tool to perform measurements on the quality of incoming signals. In addition, the novel method enables extra measurements to be made. Examples of such measurements are the measurement of the jitter that leaves the PLL, and the difference between the incoming and outgoing signal. Such measurements can be used for instance to asses the jitter present in a certain bandwidth.

The double digital PLL, which consists of an acquisition PLL and an output PLL, enables the reduction of the limit cycle to harmless levels, so that the other two factors become dominant. The double digital PLL implicitly allows for more accurate measurements.

The benefit of the novel method comes from the rapid transition from the analog domain into the quantized digital domain. Since the quantization has a feedback loop, it is possible to essentially eliminate all normal noise mechanisms such as the noise in the controlled oscillator, which is typically a voltage controlled oscillator. Once the signal is digitized all other operations become digital operations, which can be carried out with high, practically unlimited, accuracy.

The invention also provides a method of measuring the accuracy of a clock signal comprising inputting said clock signal to a double digital phase locked loop; and selectively extracting a measurement signal from extraction points within said double digital phase locked loop.

### BRIEF DESCRIPTION OF THE DRAWINGS

The invention will now be described in more detail, by way of example only, with reference to the accompanying drawings, in which:—

FIG. 1 is a block diagram of a prior art jitter detector;

FIG. 2 is a phase diagram showing the behaviour of a limit cycle;

FIG. 3 is a block diagram of a type II phase locked loop;

FIG. 4 is a block diagram of a phase locked loop with terminals for extracting measurement signals;

FIG. 5 is a first embodiment of a differential measurement arrangement;

FIG. 6 is a second embodiment of a differential measurement arrangement;

FIG. 7 is a third embodiment of a differential measurement arrangement;

FIG. 8 is a more detailed block diagram of a measurement differential arrangement; and

FIG. 9 illustrates yet another differential measurement arrangement.

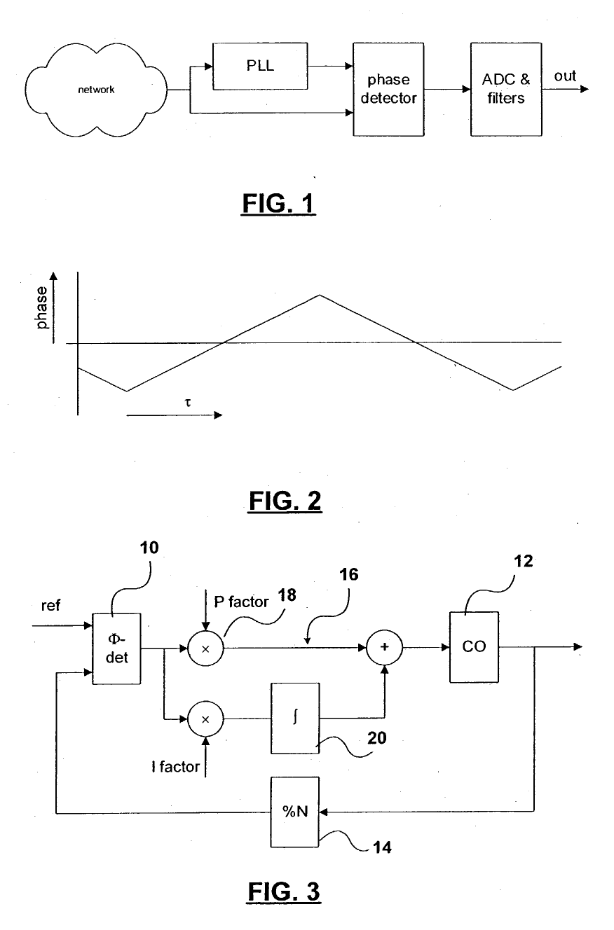

### DETAILED DESCRIPTION OF THE PREFERRED EMBODIMENTS

The novel circuit in accordance with the principles of the invention comprises a double digital phase locked loop. In such an arrangement, the size of the limit cycle is the limiting factor under which it becomes difficult to directly monitor a small signal. The limit cycle frequency and size can be influenced by changing the low pass frequency in the PLL; by halving the low pass frequency the limit cycle frequency more or less halves, as does the size of the limit cycle.

The frequency of the limit cycle is normally in the order of the low pass frequency. Typical worst case limit cycle behaviour is shown in FIG. 2. Depending on the precise implementation, a limit cycle as sketched is quite likely. The maximum phase error changes linearly from −½ quantization error to +½ quantization error. The LPF setting will be such that the observed phase error of, for instance, −½ quantization error, in a linear approach would be repaired after τ seconds. This is based upon the observation that the tangent of a first order low pass filter at time=0 will cross the end value (0) precisely at τ seconds. Thus the whole cycle will take 4τ, which makes the limit cycle frequency equal to 1/4τ. This is equal to π/2*f_{lpf}. With another implementation the precise number may shift, but it may not be expected to change drastically.

The second PLL will typically have a much lower low pass frequency. Thus the limit cycle will be significantly attenuated; it will fall in the part of the transfer that falls with for instance 20 dB/decade. This permits the limit cycle problem to be alleviated. In a specific example; suppose that the quantizer (phase detector) runs at 500 MHz. The amplitude of the limit cycle will be 2 ns/2=1 ns. Suppose that the limit cycle is related to a reference frequency of 8 kHz (which is quite low), and uses in the acquisition PLL a bandwidth of 800 Hz (just a factor 10 lower). Finally suppose that the second PLL uses a low pass frequency of 20 Hz. The following observations hold: The limit cycle will run at π/2*f_{lpf}=π/2*800=1256 Hz and be a triangular waveform. Its main component will be the base tone, having a duration of (2/π)²*amplitude, or about 0.4 ns. The other components, 3^{rd} overtone and higher, will be attenuated even more and will become negligible. A 20 Hz wide LPF will attenuate the limit cycle, so that the remaining limit cycle will be 20/1256*0.4 ns=6.5 ps.

The illustrated limit cycle is a worst case scenario. In the example shown, the quantization error is directly coupled through the digital controlled oscillator (DCO) sensitivity to effective output behaviour. This is relevant for the effective low pass frequency.

There are still various other factors that may need to be considered depending on the application. The oversample rate may be lower. A rate of one is desirable for stability. The quantization error can be reduced by having the phase detector run at higher speeds. Currently, in 0.35 μm CMOS, speeds above 600 MHz under all conditions can be implemented. In current, smaller technologies speeds can be increased above 1-5 GHz could be envisaged. Using a higher reference frequency makes it possible to start from a higher frequency.

In a specific example, suppose that the phase detector still runs at 500 MHz, so that the quantization error amplitude is at a maximum Ins. Suppose the reference frequency is 200 MHz, which is effectively (sub)sampled for phase information with 20 MHz. Then a limit cycle frequency of 10 MHz may arise. If that is suppressed with a second order filter at 1 MHz, the remaining jitter amplitude will be smaller than 1 ns/10²=10 ps, which is a very acceptable amount.

The examples show that the double PLL approach can sufficiently reduce/attenuate the limit cycle to yield very accurate phase information. Alternative arrangements, with steeper filter behaviour, are possible so that the solution can provide true high resolution.

It should be clear that the ratio of bandwidth between the first PLL and the second PLL affects the accuracy that can be attained. In general, as the accuracy increases, the bandwidth decreases. However, the actual bandwidth of interest depends on the signal measured. If, for example, the reference is only 8 kHz, sampling at 20 MHz effectively is not possible. Then again, the noise of an 8 kHz source cannot occupy a 1 MHz bandwidth, so that measurement with an 1 MHz bandwidth does not make sense. On the other side, measurement of a 200 MHz source requires a larger bandwidth.

A normal frequency source carries jitter with a spectral distribution around DC, with attenuation for higher frequencies. As a rule of thumb, oscillators are considered to have white noise above say 1 MHz, and below that the true relevant jitter frequencies. These jitter frequencies differ according to the type of environment, but typically have behaviors like 1/f, 1/f² and 1/f³. The 1 MHz boundary is a workable limit for frequencies between 100 MHz and 1000 MHz. Below 100 MHz the relevant noise bandwidth i.e. non-white-noise bandwidth) will gradually drop off. Thus for 8 kHz signal, the typical noise bandwidth will be a few 100 Hz.

Amplifiers, strings of amplifiers/repeaters, optical/electrical transitions etc. will add some noise to the oscillator noise, but will not change the properties drastically. Thus considerations for measurements are applicable in a wide environment.

The bandwidth reduction between acquisition PLL and output PLL is always feasible; for the lower reference frequencies the jitter is also spectrally smaller. For extremely high frequencies the jitter spectrum of interest does not grow out of proportion.

By analyzing the block diagram of a PLL it is possible to observe a number of places where data is available that can be used as measurement source. Data of interest is phase, first derivative of phase, which is the same as frequency, and the first derivative of frequency. The latter is referred to the Allan variance. The Allan variance is the variable used to compare independent frequency sources. The Allan variance is for independent sources more practical than frequency and phase because of scaling effects.

The block diagram of a type II PLL is shown in FIG. 3. The main components are a phase detector 10, a controlled oscillator 12, a feedback divider 14, and a loop filter 16. The phase detector 10, controlled oscillator 12 and feedback divider 14 are standard components in any PLL. The filter 16 has a specific structure, with a proportional part 18 and an integrating part 20. The integrating part 20 ensures that a frequency error on the input does not lead to a phase error. This is the element that distinguishes a type II PLL from a type I PLL. The two multiplication factors I, P are intended to specify how the transfer curve can be influenced; the P factor sets the low pass frequency and the I part together with the P part control the shape of the transfer curve.

It will be noted from FIG. 3 that the phase error appears at the output of the phase detector 10, and the frequency setting appears at the controlled oscillator input. From this point the first derivative can also be taken, which is the source for the Allan variance.

The frequency setting on the controlled oscillator has two feed nodes, which may behave differently. Both the P branch and the I branch have little quantization error. In such a case, the use of the frequency setting on the controlled oscillator is very correct.

The P branch behaves in relatively course fashion, such as may be the case in an acquisition PLL. In the frequency setting of the controlled oscillator, this appears as a course quantization. However, the integrator will be much smoother because the integrator attenuates high frequencies. Thus the accuracy of the integrator may be much higher and more stable. On the other hand, the course quantization of the P branch does not mean it will contribute on average. For instance, the acquisition PLL may track the signal so closely that the contribution of the P branch practically zero. Thus, it may be better not to use the P branch, and only use the frequency from the I branch.

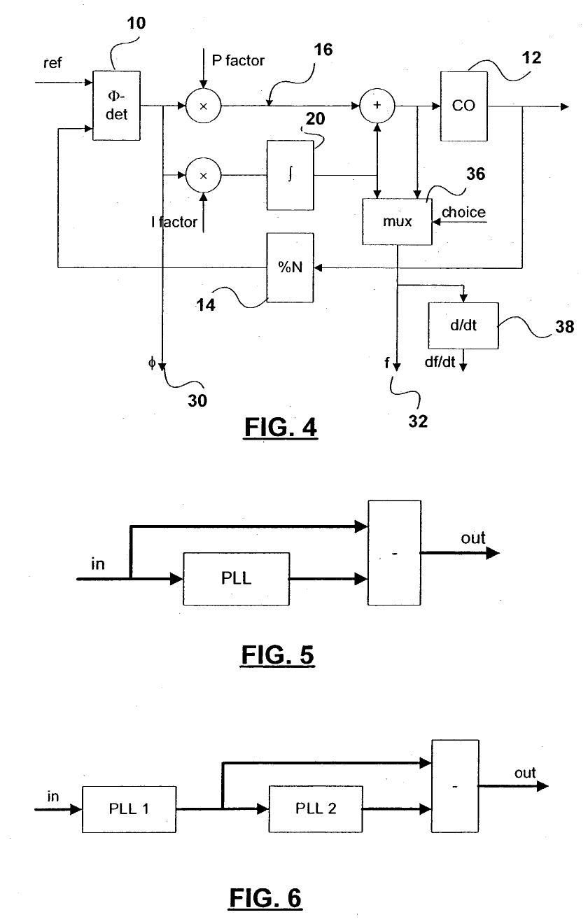

FIG. 4 illustrates the samples are extracted. The phase error, frequency and derivative of frequency appear respectively at terminals 30, 32, 34. Mux 36 selects inputs between the input to the controlled oscillator and the output of the integrator 20. The multiplexer 36 is controlled by a user signal choice.

In the measurement of jitter on a network, a first model uses noise as a modulation source on the frequency source. In order to capture the properties of such a model, statistical measurements on the data are very useful. If statistical measurements are not used, the quantity of data can be quite large. Instead it is much simpler to obtain large datasets for phase, frequency and first derivative of frequency and calculate average and standard deviation. Such measurements take little computing power and do condense data to relevant representations. Average and standard deviation each take one calculation per sample, and a calculation afterwards to get the final results. Thus the order of the calculations is O(N). The memory consumption is fixed and takes only a single place for summation, summation of squares and number of samples. Thus the memory consumption is order O(1).

A good extra representation, which is dense, is the median of measurements. The median can be used, by comparison with the average, to get an impression of the statistical model of spread of the jitter: Gaussian, Poison etc. If the median needs to be calculated, a sorting structure is necessary. An optimal sorting structure that performs well under all circumstances requires O(NlogN) operations, and N memory locations. For implementations in hardware, such memory consumption may be too large, in which case the alternative is to use not the median but the minimum and the maximum. These two values are again order O(N) for the calculation and order O(1) for memory.

A further model for jitter may assume more structure in the jitter. It depends on the precise required information that is to be obtained, what form the data reduction can take. For example, an FFT (Fast Fourier Transform) may be used to calculate certain pieces of the spectrum. In a complete FFT there is no data reduction, but only a different representation that may simplify other operations. The order of the operations and the memory consumption of the FFT are high, so that may not be very attractive. Also, high accuracies require large FFT sets, which increases the overhead.

Instead of a complete sorting structure, it possible to use categories of jitter size, which in software are called ‘bins’. Sorting in bins may require less memory and operations than a complete sorting. On the other hand, defining the locations of the bins in advance may be difficult. An adaptive algorithm, that can ‘move’ bins around, is typically difficult to manage unless it is acceptable to loose older data when the bins are changed.

In making clocking measurements, it is quite common to make a distinction between common mode and differential effects. For jitter measurements this can be implemented by measuring the difference between, for instance, two phase errors. The result of such a measurement can be used to obtain information about the correlation of the two phase errors. The same applies to frequency measurements, first derivative of frequency etc.

The difference operator cannot be applied after statistical operations upon the data. Statistical results cannot be subtracted of each other without incurring many extra conditions. It is in fact much better to perform subtractions before the statistical measurements. The same applies to bin sorted data, the median and the like. This defines the sequence of subtractions and statistical operations.

The points where the two sides of a differential measurement can be chosen by the user. Practical arrangements in accordance with embodiments of the invention are shown in FIGS. 5 to 9.

In FIG. 5, the out signal reflects the jitter that is attenuated by the PLL. Since a PLL typically will have low pass behaviour the out signal will have high pass behaviour, attenuated around DC.

In the arrangement shown in FIG. 6, the out signal reflects again the attenuated signal above the low pass frequency of PLL 2. However, the signal is now already band limited by PLL 1, so that the signal will be attenuated above the low pass frequency of PLL 1. Thus the out signal will represent the input signal in within the band set by the two low pass frequencies.

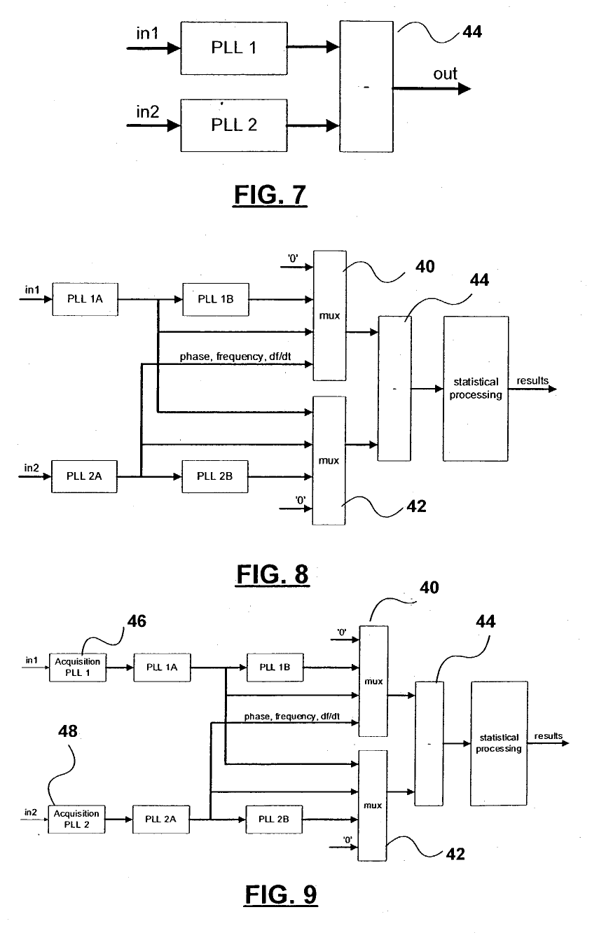

In the arrangement shown in FIG. 7, the out signal will reflect the difference of the two inputs. If there is a strong correlation between the two input signals, the output signal out will be small. In theory, when the inputs are identical, the output will be 0.

The variables from within the PLL can be connected to outside circuits, as demonstrated with reference to FIG. 4, with a choice of points from where to extract the frequency. All variables, phase, frequency and first derivative of the frequency can be used to feed the other operations in all configurations. In FIG. 8, the PLL is used as a building block in a hierarchical arrangement.

Except for the control within the PLL, to select where the actual frequency read-out is coming from, the multiplexers 40, 42 control the functionality. Phase, frequency and the derivative of frequency are drawn as one entity, but of course they can be treated separately. This requires multiple multiplexers and multiple subtractor blocks 44.

The muxes 40, 42 permit all the illustrated configurations to be implemented; absolute values (by asserting the other input of the subtractor a ‘0’), the attenuated phase, the difference of two inputs, possibly after filtering.

It may be desirable to have the acquisition PLL not used as PLL 1A or PLL2A. If the bandwidth of the first PLL limited, the acquisition of the signal may be affected. As long as all components in the system remain linear under all conditions, the use of a small bandwidth in the acquisition PLL is not a problem. But that may not be realistic under all conditions. In this case a variation shown in FIG. 9 can be used. Two leading acquisition PLLs 46, 48 are responsible for making an image of the incoming physical signal, and the remaining PLLs are responsible for supplying the correct measurement data. This creates a separation between the different parts of the system. This last configuration is slightly more flexible.

It will be appreciated by one skilled in the art that many further variants are possible without departing from the scope of the appended claims.

1. A circuit for measuring the accuracy of a clock signal comprising:
a first digital phase locked loop receiving an input signal and providing an output signal;
a second digital phase locked loop receiving at its input said output signal from said first phase locked loop;
a measurement terminal for providing a measurement signal; and
a multiplexer for selectively connecting said measurement terminal to a signal extraction point in said circuit.

2. A circuit as claimed in claim 1, wherein one of said phase locked loops comprises an integrator and a controlled oscillator, and said multiplexer selectively connects said measurement terminal to an output of said integrator and an input of said controlled oscillator to provide a frequency signal.

3. A circuit as claimed in claim 1, wherein a further measurement terminal is connected to an output of a phase detector of said first digital phase locked loop to provide a phase signal.

4. A circuit as claimed in claim 1, further comprising a differentiator having an input connected to the output of said multiplexer and an output connected to a third said terminal for providing an output signal that is a derivative of frequency.

5. A circuit as claimed in claim 1, further comprising a third digital phase locked loop receiving an input signal and providing an output signal; a fourth digital phase locked loop receiving at its input said output signal from said third phase locked loop; and at least one said measurement terminal internally connected to at least one of said third and fourth phase locked loops to provide a measurement signal.

6. A circuit as claimed in claim 5, wherein said third and fourth phase locked loops are provided in a differential arrangement with said first and second phase locked loops.

7. A circuit as claimed in claim 5, further comprising a pair of multiplexers for respectively selecting said signals at the measurement terminals associated with said first and second phase locked loops and the signals associated with the measurement terminals of said third and fourth phase locked loops, and a subtractor for subtracting the selected signals from each other.

8. A circuit as claimed in claim 7, wherein said subtractor has an output connected to a statistical unit for processing the output of said subtractor.

9. A circuit as claimed in claim 7, further comprising separate acquisition phase locked loops upstream of said respective first and third phase locked loops.

10. A circuit as claimed in claim 1, wherein said second digital phase locked loop has a substantially lower pass frequency than said first digital phase locked loop

11. A method of measuring the accuracy of a clock signal comprising:
inputting said clock signal to a double digital phase locked loop; and
selectively extracting a measurement signal from extraction points within said double digital phase locked loop.

12. A method as claimed in claim 11, wherein said measurement signal is extracted from an output of a phase detector one of said phase locked loops to provide a phase signal.

13. A method as claimed in claim 12, wherein a frequency measurement signal is selectively extracted from an output of an integrator or a controlled oscillator in the other of said phase locked loops.

14. A circuit as claimed in claim 13, wherein said frequency signal is differentiated to provide a derivative of said frequency signal.

15. A method as claimed in claim 11, wherein a pair of said double digital phase locked loops are arranged in a differential arrangement, and a difference measurement signal is derived from the output of said differential arrangement.

16. A method as claimed in claim 15, wherein a measurement signal from each of said phase locked loops is selected with a multiplexer.

17. A method as claimed in claim 11, wherein said second digital phase locked loop has a substantially lower pass frequency than said first digital phase locked loop
